(19) United States
(12) Patent Application Publication
(10) Pub. No.: US 2010/0150590 A1
(43) Pub. Date: Jun. 17, 2010

(54) IMAGE FORMING APPARATUS

(76) Inventor: Takeshi YOSHINO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/637,161

(22) Filed: Dec. 14, 2009

(30) Foreign Application Priority Data
Dec. 17, 2008 (JP) JP2008-320661

(51) Int. Cl. G03G 15/00

(52) U.S. Cl. 399/49

(57) ABSTRACT

An image forming apparatus including: a control section that detects an amount of light emitted from light emitting section and controls an amount of light emitted, and forms a patch in a non-image transfer region of a photoreceptor, and controls image forming conditions according to a detected result of density of the patch formed on the non-image transfer region; wherein said control section, during an interval between sheets, which corresponds to an interval between a period of image formation of a first image to be transferred to said recording sheet and a period of image formation of a second image to be transferred to next recording sheet, forms said patch by carrying out light amount control for forming said patch, and carries out light amount control for forming images to be transferred to said recording sheet.

### RELATED APPLICATION

This application is based on Japanese Patent Application No. 2008-320661 filed with Japanese Patent Office on Dec. 17, 2008, the entire content of which is hereby incorporated by reference.

### BACKGROUND OF THE INVENTION

1. Field of the Invention

The present invention relates to image forming apparatuses such as copying machines or printers, etc., and in particular to image forming apparatuses that are provided with the function of detecting the amount of light emitted by a light emitting section and controlling that amount of light emitted, and a function of forming a patch using that light emitting section and controlling the image forming conditions according to the result of detecting the density of that patch.

2. Description of the Related Art

Existing image forming apparatuses form images by forming an electrostatic latent image on an image carrier based on image data, generating an apparent image (also called a visible image or a toner image) by developing that electrostatic latent image using a developing agent (toner), and in addition, transferring the generated toner image from the image carrier to a recording sheet using a transfer electric current from a transfer section, separating said recording sheet and said image carrier using a separating electric current from a separating section, and fixing the toner image by applying heat and pressure to the recording sheet carrying a toner image on it.

In such an image forming apparatus, by controlling the various types of parameters of image forming conditions, execution of image formation is being made with an appropriate density.

Here, the conditions of charging, development, transfer, etc., are present as the image forming conditions. For example, by applying a transfer electric current from the transfer section to the image carrier and the recording sheet, the toner image is being transferred to a recording sheet, depending on the current value of this transfer electric current the percentage of the toner transferred to the recording sheet changes. Further, it is also known that the transfer efficiency also changes depending on the size, thickness, and material characteristics of the recording sheet, the temperature, humidity, amount of electric charge of the toner on the photoreceptor, amount of toner adhered, dirtiness of the transferring section, state of moisture absorption of the recording sheet, state of close contact between the recording sheet and the photoreceptor, rotational speed of the photoreceptor, conveying speed of the recording sheet, etc., and while it is necessary to carry out adjustments considering there various conditions, it is difficult to adjust to the optimum transfer electric current value.

Because of this, a technology is present in which a toner image of a patch according to image data of a prescribed density is formed either on the photoreceptor or on the recording sheet, the density of the toner image of that patch is measured, and the different image forming conditions are corrected for based on the difference between the density predicted from the image data and the measured density.

Further, regarding such patch formation—measurement—image formation condition corrections, while conventionally it was common to carry them out by providing a dedicated time, it is desirable to carry them out during the execution of image formation from the point of view of improvements in productivity.

In other words, it is possible to carry this out in real time during the execution of image formation, by reading out using a sensor a patch on the photoreceptor using a non-image transfer area on the photoreceptor, that is, between the images to be transferred (between sheets). By doing so, there is no need to stop image formation, and the productivity gets enhanced. Descriptions about this type of technology have been given in Japanese Patent Application Publication No. 2005-289035.

Further, in order to execute image formation with a prescribed density, it is necessary to detect the amount of light (LD power) emitted from a light emitting section such as an LD, etc., and to control the amount of light. In other words, since the relationship between the electric current fed to the laser diode and the optical output differs depending on the individual laser diode, and also since it changes depending on the heat generation by the laser diode itself, it is not possible to cause laser emission by constant current control. Because of this, it is necessary to monitor the optical output of the laser and to carry out control so that a prescribed optical output level is obtained. This control is called Auto Power Control (APC).

Descriptions regarding this auto power control have been given in Japanese Patent Application Publication No. Hei 7-36312 and Japanese Patent Application Publication No. Hei 7-171995.

### SUMMARY

In order to execute density control between sheets without recording on the recoding sheet, it is necessary to execute between sheets the sequence of operation of automatic light amount control for the patch for density measurement, density control using the patch for density measurement, and automatic light amount control for normal images.

However, in recent years, since increasing the productivity is being considered important, the interval between sheets has become narrow, and since the time for carrying out this sequence of operations has become short, there is the problem that sufficient time cannot be obtained.

In either of the above Japanese Patent Application Publication No. 2005-289035, Japanese Patent Application Publication No. Hei 7-36312 and Japanese Patent Application Publication No. Hei 7-171995, considerations have not been given for the automatic light amount control for the patch for density measurement, and the operation of the sequence of operations of light amount control for normal image formation. In other words, while it is necessary to execute between sheets the automatic light amount control for the patch for density measurement, adjustment by the patch for density measurement, and the automatic light amount control for normal image formation, no disclosure has been made as to how this sequence of operations are realized between sheets.

Further, in a color image forming apparatus, adjustments will be necessary for each of the colors YMCK, and the processing in a short time becomes even more difficult. In view of this, during a control using ordinary software, there is the possibility that the above sequence of operations cannot be completed between sheets.

The present invention was made in order to solve the above problem, and the purpose of the present invention is to realize an image forming apparatus that is capable of carrying out high accuracy density control by using the time interval between sheets the two types of light amount control, one for a patch for density control and another for normal image formation.

According to one aspect of the present invention, there is provided, an image forming apparatus that forms a latent image by exposing a photoreceptor using a light emitting section, and transfers a toner image obtained by developing the latent image on to a recording sheet, the image forming apparatus comprises: a control section that detects an amount of light emitted from said light emitting section and controls the amount of light emitted from said light emitting section, and forms a patch in a non-image transfer region of said photoreceptor, where an image to be transferred on to the recording sheet is not formed on the non-image transfer region, and controls the image forming conditions according to a detected result of density of the patch formed on the non-image transfer region; wherein said control section, during an interval between sheets, which corresponds to an interval between a period of image formation of a first image to be transferred to said recording sheet and a period of image formation of a second image to be transferred to next recording sheet, forms said patch by carrying out light amount control for forming said patch, and carries out light amount control for forming images to be transferred to said recording sheet.

In the image forming apparatus of one aspect of the present invention, said control section carries out at least once the light amount control for forming said patch and carries out light amount control once for the formation of images to be transferred to said recording sheet.

According to another aspect of the present invention, there is provided an image forming apparatus that forms a latent image by exposing a photoreceptor using a light emitting section, and transfers a toner image on to a recording sheet, the image forming apparatus comprising: a D-A converter whose output sets the amount of light of said light emitting section, and a control section that detects an amount of light emitted from said light emitting section and controls the amount of light emitted from said light emitting section, and forms a patch in a non-image transfer region of said photoreceptor, where an image to be transferred on to the recording sheet is not formed on the non-image transfer region, and controls the image forming conditions according to a detected result of density of the patch formed on the non-image transfer region; wherein said control section, stops the emission of light from said light emitting section at the start of a patch region signal indicating a patch formation region within the interval between sheets and gives a set value of the control of the amount of light for forming said patch to said D-A converter, thereafter forming said patch by carrying out initial automatic light amount control and automatic light amount control outside the region for every exposure scan, and wherein the control section, stops the emission of light from said light emitting section at the end of said patch region signal and gives a set value of the control of the amount of light for forming the image to be transferred to a recording sheet to said D-A converter, and thereafter carries out initial automatic light amount control and automatic light amount control outside the region for every exposure scan.

### BRIEF DESCRIPTION OF THE DRAWINGS

FIG. 1 is a configuration diagram showing the configuration of an image forming apparatus according to a preferred embodiment of the present invention.

FIG. 2 is a configuration diagram showing the configuration of an image forming apparatus according to a preferred embodiment of the present invention.

FIG. 3 is a time chart showing the operation of an image forming apparatus according to a preferred embodiment of the present invention.

FIG. 4 is a time chart showing the operation of an image forming apparatus according to a preferred embodiment of the present invention.

FIG. 5 is a time chart showing the operation of an image forming apparatus according to a preferred embodiment of the present invention.

FIG. 6 is a time chart showing the operation of an image forming apparatus according to a preferred embodiment of the present invention.

### DESCRIPTION OF THE PREFERRED EMBODIMENT

A preferred embodiment of the present invention is described below with reference to the drawings.

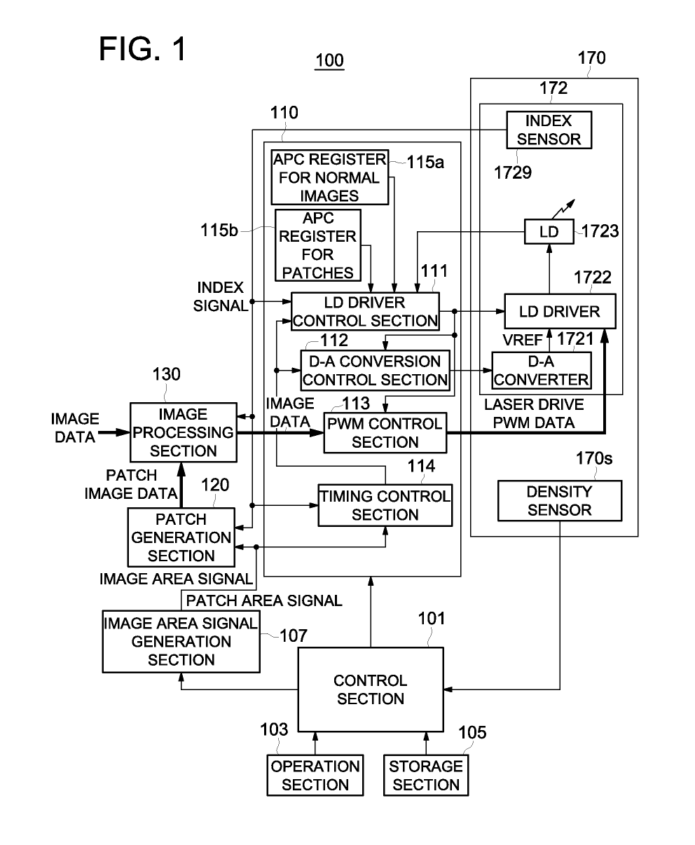

The configuration of an image forming apparatus 100 according to the present preferred embodiment is described in detail based on FIG. 1.

However, explanations of the parts that are already known as an image forming apparatus and that are not directly related to the operations and control that are characteristic of the present preferred embodiment have been omitted. Further, in the present preferred embodiment, the direction of moving the image carrier or of conveying the recording sheet is called the auxiliary scanning direction. In addition, a direction that is at right angles to this auxiliary scanning direction is called the main scanning direction. Two dimensional images are formed by exposing the top of the image carrier in the main scanning direction while conveying the recording sheet along the auxiliary scanning direction and moving the image carrier along the auxiliary scanning direction, and the desired image is formed on the recording sheet by transferring this image on the image carrier on to the recording sheet.

In addition, in the present preferred embodiment, the region at the top surface of the image carrier in which at least one of the main scanning direction image area signal and the auxiliary scanning direction image area signal is inactive implies the “non-image transfer region” in which the image is not transferred to a recording sheet. In other words, a non-image transfer region is a region at the top surface of the image carrier in which an image to be transferred on to a recording sheet is not formed.

Further, in the present preferred embodiment, the non-image transfer region between the validity interval of the auxiliary scanning direction image area signal and the next validity interval of the auxiliary scanning direction image area signal is called the “between sheets interval”.

In the image forming apparatus 100, the control section 101 is configured using a CPU, etc., for controlling the different parts of the image forming apparatus 100.

The operation section 103 is one for the operation of the image forming apparatus to make various types of operation inputs, and is provided with various types of switches and keys, etc.

The storage section 105 is a storage section that stores various types of data, and in the present preferred embodiment, it has the densities or patterns of the patch used at the time of controlling the image conditions, the position of forming the patch, and various types of data at the time of carrying out control.

The image area signal generating section 107 generates an auxiliary scanning direction image area signal (V-Valid) indicating the auxiliary scanning direction of the image forming area (image transfer area) on the image carrier, a main scanning direction image area signal (H-Valid) indicating the main scanning direction of the image forming area (image transfer area) on the image carrier, and the patch area signal (P-Valid) indicating the patch area in which the patch is to be formed in the non-image transfer area between sheets.

Further, the LD writing control section 110 is configured to have an LD driver control section 111 that generates the LD driver driving signal, a D-A conversion control section 112 that generates the reference voltage Vref for the D-A converter, a PWM control section 113 that generates the laser driving PWM signal corresponding to the image data, a timing control section 114 that generates the timing signals necessary for the light emission timing of the LD based on the image area signals and the patch area signal, an APC register for normal images 115a in which is stored the APC data for normal image formation (the target value data for the light amount control for normal image formation), and an APC register 115b in which is stored the APC data for patch formation (the target value data for the light amount control for patch formation), and mainly carries out control related to the exposure due to light emission by the laser diode LD.

Further, this control section 101 and the LD writing control section 110 configure the control section according to the claims of the present preferred embodiment.

In addition, this control section (the control section 101 and the LD writing control section 110), in the between sheets interval between the image forming interval of forming images that have to be transferred to a recording sheet and the image forming interval of forming images that have to be transferred to the next recording sheet, carry out at least—

(a) Light source light amount control for patch formation (APC for patch formation),

(b) Density control of image formation condition adjustments based on patch formation and results of the read out, and

(c) Light source light amount control for the formation of images to be transferred to the next sheet (APC for normal image formation).

The patch image data generation section 120 is one that generates the patch image data in the non-image transfer area (the between sheets interval) according to the patch area signal, and supplies the patch image data to the image processing section 130 to be described later.

Further, while the patch image data generation section 120 is one that generates various types of patches such as the density patch for density control, the registration patch for registration adjustment, and the toner band patch, etc., and in this preferred embodiment, it generates at least the density patch.

The image processing section 130 carries out image processing for making the image data of the images to be formed and the patch into a condition that is suitable for image formation, and supplies the processed image data to the PWM control section 113 inside the LD writing control section 110.

The process unit 170 is a section that executes various types of operations for forming images (toner images) on recording sheets, and in FIG. 1, it is provided with a density sensor 170s that detects the density of the patch formed on the photoreceptor, and an exposure section 172.

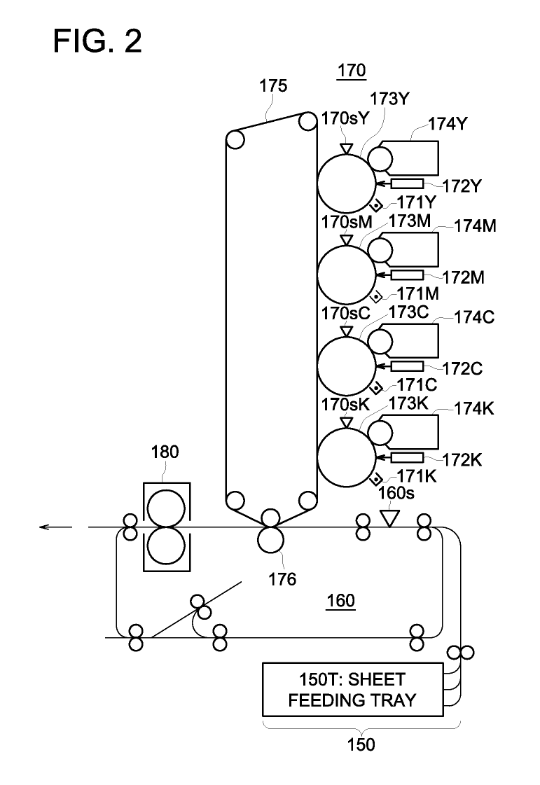

In this exposure section 172, the configuration is made to have at least a D-A converter 1721 that receives the output from the D-A conversion control section 112 and generates the reference voltage Vref, an LD driver 1722 that receives the laser driving PWM data from the PWM control section 113, the reference voltage Vref from the D-A converter 1721, and the control signal generated in and received from the LD driver control section 111, a laser diode (LD) 1723 that receives the LD drive signal from the LD driver 1722 and emits light, and an index sensor 1729 that receives the light emitted from the laser diode LD 1723 and is scanned by a polygon mirror (not shown in the figure) and generates the index signal. Further, the LD 1723 is configured to have inside the device unit a circuit that gives a monitor output of the light emission intensity, and the monitor output is supplied to the LD driver control section 111. In addition, other configuration aspects of the process unit 170 are explained in detail referring to FIG. 2.

Further, in the configuration of this FIG. 1, if this apparatus is a color image forming apparatus, the configuration shown is that for any one of the colors. For example, if it is a YMCK four color image forming apparatus, four sets of the LD writing control section 110 and the process unit 170 are placed corresponding to the four colors. Further, when exposure with a plurality of laser beams is made for the different colors, to match the number of laser beams, a plurality of sets of the exposure section 172 can be placed, or they can be placed for a plurality of channels.

Next, the mechanical configuration of the image forming apparatus 100 is described referring to FIG. 2.

The sheet feeding section 150 is a sheet feeding means that feeds out the recording sheets a plurality of which is stacked in a sheet feeding tray 150T and conveys the sheet up to the image forming position by the sheet feeding rollers.

The conveying section 160 is a conveying means that conveys the recording sheet fed out from the sheet feeding section 150 with a prescribed conveying speed, and is configured to have registration rollers and other various types of conveying rollers, conveying belt, etc. In addition, at the prescribed positions of the different sections of the conveying section 160 are placed the conveying sensors 160s such as the front edge detection sensor that detects the front edge of the recording sheet.

The process unit 170 is a means that executes various types of operations of forming images on recording sheets, and is provided with a charging section 171 that charges the photoreceptor 173 to a prescribed level, an exposing section 172 that exposes the photoreceptor 173 according to the image data, a photoreceptor 173 as an image carrier on which an electrostatic latent image is formed due to exposure, a developing section 174 that converts by developing the electrostatic latent image on the photoreceptor 173 into a toner image, an intermediate image transfer member 175 as an image carrier that carries the toner image after the toner image on the photoreceptor 173 is transferred on to it, and a transfer section 176 having a transfer roller 176a and a transfer roller 176b.

Further, in case the image forming apparatus is a color image forming apparatus that synthesizes toner images of multiple colors, as is shown in FIG. 2, the configuration is such that, in the process unit 170, the charging section 171, the exposing section 172, the photoreceptor 173, and the developing section 174 are provided corresponding to each color, the toner images of different colors are superimposed on one another on the intermediate image transfer member 175, and finally transferred on to a recording sheet.

Further, for each of the photoreceptors 173Y, 173M, 1730, and 173K respectively as image carriers, are placed the sensors 170sY, 170sM, 170sC, and 170sK, respectively, which detect the patch formed in the non-image transfer area. Further, here, although sensors have been provided for each photoreceptor section, it is also possible to detect the patch on the intermediate image transfer member 175.

The fixing section 180, while gripping and conveying the recording sheet onto which a toner image has been transferred, carries out fixing by applying heat and pressure thereby making the toner image go into a stable state on the recording sheet.

### Operation of the Present Preferred Embodiment

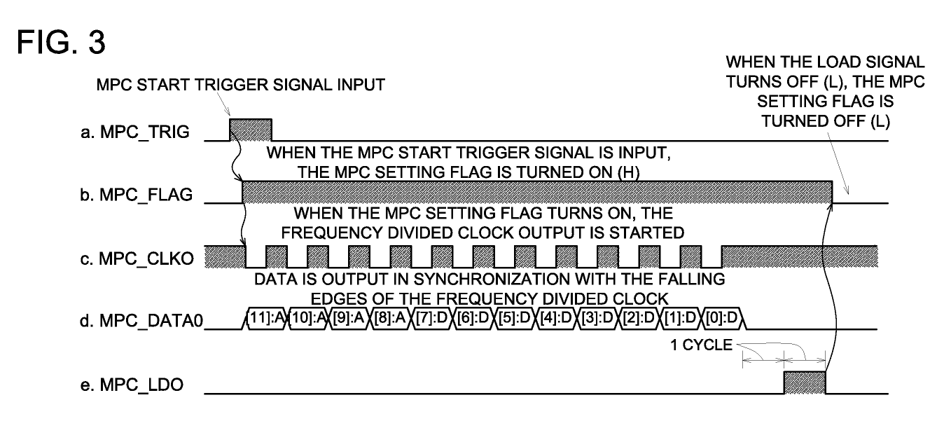

Descriptions of operations of an image forming apparatus of the present preferred embodiment are given below with reference to the explanatory drawings of FIGS. 3 to 5.

At the time of density control, a prescribed density patch is formed on the photoreceptor 173 by the exposing section 172, this patch is read out by the sensor 170s, and according to the result of that read out, the control section 101 sets the image forming conditions.

Because of this, in order to form a patch with a prescribed correct density, firstly, it is necessary to carry out automatic light amount control (APC) so that the LD 1723 emits light at the desired optical output level in accordance with the prescribed data.

In order to do this, it is necessary to carry out a sequence of processes by serial communication between the D-A conversion control section 112 and the D-A converter 1721 in the sequence of MPC (APC target value setting) operation, starting APC operation, and normal APC operation.

Here, to begin with the D-A conversion control section 112 generates the MPC start trigger signal MPC_TRIG (“a” of FIG. 3). Upon receiving the input of this MPC start trigger signal, the MPC setting flag MPC_FLAG is turned ON (H level) (“b” of FIG. 3).

Furthermore, when this MPC setting flag MPC_FLAG is turned ON (H level), the frequency divided clock MPC_CLK0 is started to be output from the LD driver control section 111 “c” of FIG. 3).

In addition, synchronizing with the falling edge of this frequency divided clock MPC_CLK0, data output is started from the LD driver control section 111 to the D-A converter 1721 (“d” of FIG. 3).

Next, at the point in time when the data output stops for one clock cycle period, the pulse of the MPC load signal MPC_LD0 is output, and the MPC setting flag MPC_FLAG turns OFF at the falling edge of this pulse.

In this manner, MPC (APC target value setting) operation is done from the D-A conversion control section 112 on the D-A converter 1721. Next, the D-A converter 1721 in which the target value has been set emits the set amount of light, and the monitor output during that light emission is posted to the LD driver control section 111. Because of this, the LD driver control section 111 obtains the correction coefficient so that the LD is made to emit light with the desired amount of light. Further, this correction coefficient is posted to either the LD driver 1722 or the PWM control section 113, and control is carried out so that the desired amount of light according to the value of the data is obtained during patch formation or during image formation. Further, this automatic light amount control operation is executed for the patch in the between sheets interval described later or for normal images, and is executed outside the area in the main scanning direction during normal image formation.

Next, the between sheets processing is described which is the characteristic part of the present preferred embodiment.

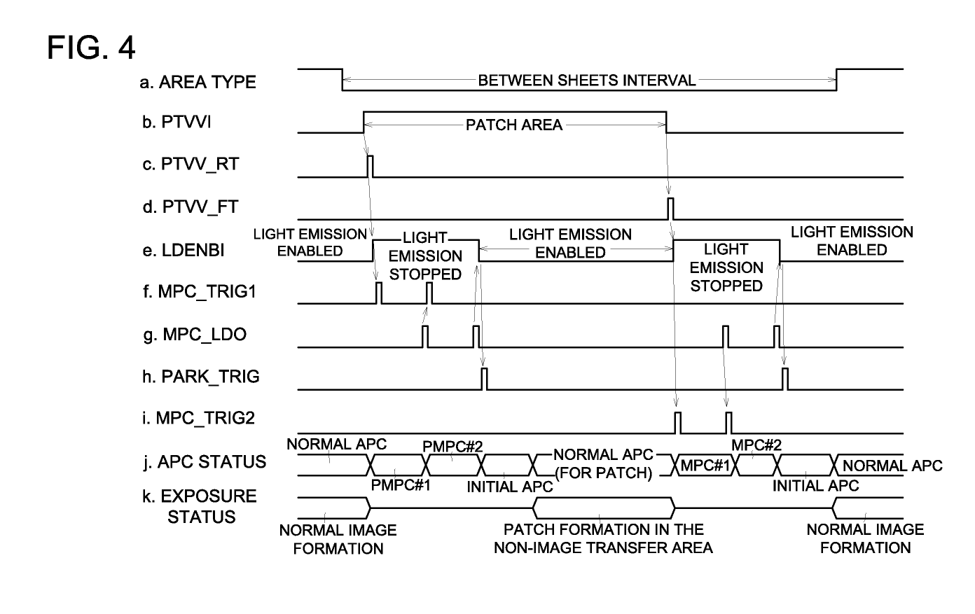

Here, in the time interval from the end of normal image formation of transferring images to a preceding recording sheet until the beginning of normal image formation for the next recording sheet (see the “between sheets interval” of “a” of FIG. 4), the timing control section 114 that has detected the start of the ON (H) state of the patch area signal PTVVI from the image area signal generation section 107 (the rising edge of PTVV_RT (“c” of FIG. 4)) turns the LDENBI signal ON (H) (the first “light emission stop” of “e” of FIG. 4) to the LD driver control section 111 in order to give an LD 1723 light emission stop instruction.

Further, following the procedure already described regarding FIG. 3, the D-A conversion control section 112 generates the first MPC start trigger signal MPC_TRIG1 (“a” of FIG. 3, “f” of FIG. 4). Next, according to the procedure described regarding FIG. 3, the data of the APC target value is transmitted to the D-A converter 1721. Here, the data of the APC target set value for the patch is transmitted to the D-A converter 1721.

Here, at the instant in time when the data transmission of the first APC target set value for the patch is completed, and the pulse of the MPC load signal MPC_LD0 (“g” of FIG. 4) is output, according to the same procedure, the data transmission of the second APC target set value for the patch is carried out (PMPC#1 and PMPC#2 of “j” of FIG. 4).

Next, at the instant in time when this data transmission of the second APC target set value for the patch is completed and the pulse of the MPC load signal MPC_LD0 is output (“g” of FIG. 4), the LD driver control section 111 turns OFF (L) LDENBI, releases the light emission stop state of the LD 1723 thereby putting the LD 1723 in the light emission enabled state (the “light emission enable” after the first “light emission stop” in “e” of FIG. 4).

Here, the data of the APC target set value for the patch is the automatic light amount control for the patch in order to make the LD 1723 emit light of the desired light amount for the toner density with which to form the patch.

Further, this data of the APC target set value for the patch is the data stored in advance in the APC register 115b for patch that is read out by the LD driver control section 111 and given to the D-A conversion control section 112. In this manner, by reading out from a register the data that has been prepared in advance, it becomes possible to carry out speedy processing in the between sheets interval.

In this state, the LD 1723, in accordance with the set value, starts executing APC for the patch. Here, as the APC for the patch, there are, following the setting of the data of PMPC#1 and PMPC#2, the starting APC of gradually increasing the light amount of the LD 1723, and following that, the normal APC for the patch (“j” of FIG. 4).

Further, in parallel with this normal APC for the patch, a patch is formed in the non-image transfer area on the photoreceptor 173, this patch is read out by the density sensor 170s, and the control section 101 determines the image formation conditions so that image formation can be carried out with the desired density.

In the case of the present preferred embodiment, since the patch for density control is being formed by executing automatic light amount control for the patch, it is possible to form an extremely accurate patch, and as a result, it is possible to realize accurate density control.

Here, in the time interval from the end of normal image formation of transferring images to a preceding recording sheet until the beginning of normal image formation for the next recording sheet (see the “between sheets interval” of “a” of FIG. 4), the timing control section 114 that has detected the end (OFF (L) state) of the patch area signal PTVVI from the image area signal generation section 107 (the falling edge of PTVV_FT (“d” of FIG. 4)) turns the LDENBI signal ON (H) (the second “light emission stop” of “e” of FIG. 4) for the LD driver control section 111 in order to give an LD 1723 light emission stop instruction.

Next, following the procedure described already regarding FIG. 3, the D-A conversion control section 112 generates the second MPC start trigger signal MPC_TRIG2 (“a” of FIG. 3, “i” of FIG. 4). Next, according to the procedure described regarding FIG. 3, the data of the APC target value is transmitted to the D-A converter 1721. Here, the data of the APC target set value for normal image formation is transmitted to the D-A converter 1721.

Here, at the instant in time when the data transmission of the first APC target set value for normal image formation is completed, and the pulse of the MPC load signal MPC_LD0 (“g” of FIG. 4) is output, according to the same procedure, the data transmission of the second APC target set value for normal image formation is carried out (MPC#1 and MPC#2 of “j” of FIG. 4).

Next, at the instant in time when this data transmission of the second APC target set value for normal image formation is completed and the pulse of the MPC load signal MPC_LD0 is output (“g” of FIG. 4), the LD driver control section 111 turns OFF (L) LDENBI, releases the light emission stop state of the LD 1723 thereby putting the LD 1723 in the light emission enabled state (the “light emission enable” after the second “light emission stop” in “e” of FIG. 4).

Here, the data of the APC target set value for normal image formation is the automatic light amount control for normal image formation in order to make the LD 1723 emit light of the desired light amount for the toner density with which to form normal images.

Further, this data of the APC target set value for normal image formation is the data stored in advance in the APC register 115a for normal image formation that is read out by the LD driver control section 111 and given to the D-A conversion control section 112. In this manner, by reading out from a register the data that has been prepared in advance, it becomes possible to carry out speedy processing in the between sheets interval.

In this state, the LD 1723, in accordance with the set value, starts executing APC for normal image formation. Here, as the APC for normal image formation, there are, following the setting of the data of MPC#1 and MPC#2, the starting APC of gradually increasing the light amount of the LD 1723, and following that, the normal APC for normal image formation (“j” of FIG. 4).

In this manner, after carrying out density control using a patch and automatic light amount control for patches in the patch area during the between sheets interval, using the free time until starting the next image formation, by starting automatic light amount control during the next image formation, it is possible to execute light amount control for obtaining the optimum toner density from the part of the beginning of the next image formation.

In the case of the present preferred embodiment, since the patch for density control is being formed by executing automatic light amount control for the patch, it is possible to form an extremely accurate patch, and as a result, it is possible to realize accurate density control.

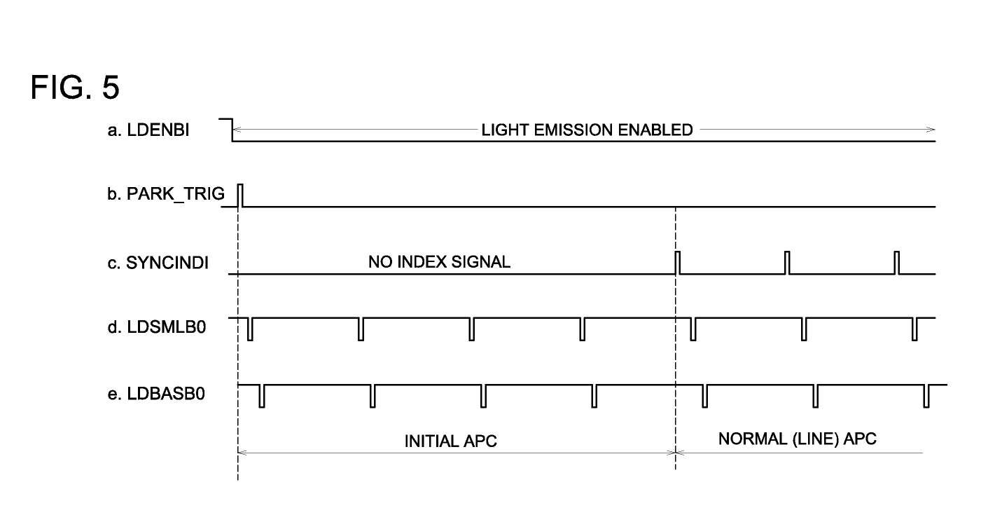

Further, in FIG. 4, at the instant in time when the starting APC is being carried out (the first half part of LDENBI in “e” of FIG. 4 and “a” of FIG. 5), the scanning of the laser beam of LD 1723 is not being made and an index signal is not present (the first half of “c” of FIG. 5). Here, it is sufficient if the timing control section 114 generates the timing signals LDSMLB0 and LDBASB0 (“d”, “e” of FIG. 5) and supply them to the LD driver control section 111.

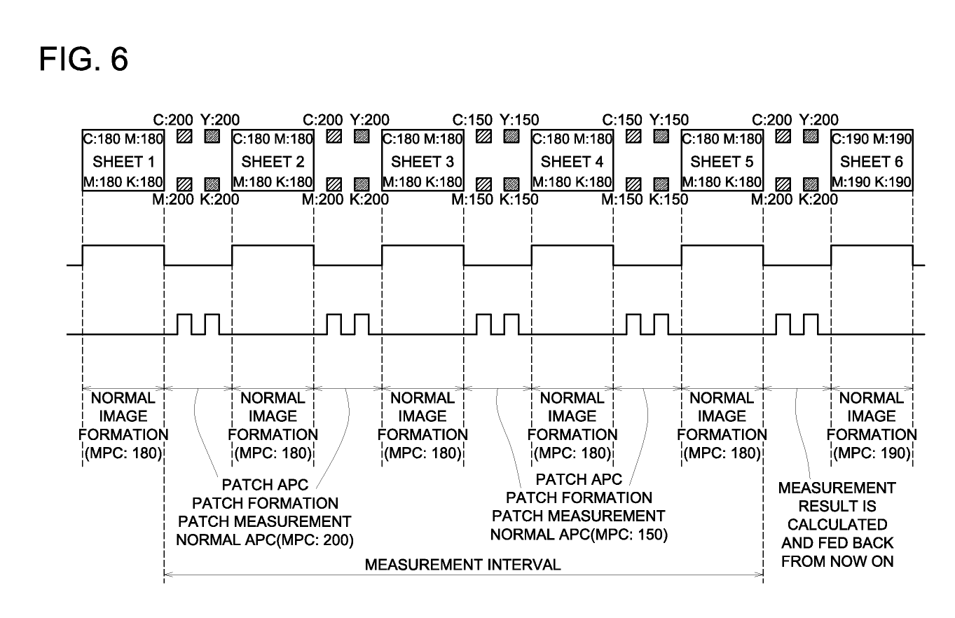

FIG. 6 is an explanatory diagram showing schematically the form of density control by the present preferred embodiment. Here, an example is shown of, during the image formation of pages 1 to 6, how APC for patch and APC for normal image formation are being executed based on target set values during the image formation of each of the pages 1 to 6 and between each pairs of pages (between pages 1-2, between 2-3, between 3-4, between 4-5, and between 5-6).

In the example shown here, in the case in which the data is in 256 levels from 0 to 255, the density is relatively high and also a region is being used that has relatively good linearity just before saturation at the highest density, in the between sheets intervals during the image formations of pages 1 to 5, APC for the patch and patch formation are being made with a data value of 200 between pages 1-2 and between pages 2-3. Further, between pages 3-4 and between pages 4-5, the APC for patch and patch formation is being made with a data value of 150.

In this case, regarding the set value for the APC for the patch, it is sufficient that a suitable value is read out from the stored values in the APC register for the patch 115b.

Because of this, due to the patch formation and measurement between pages from pages 1 to 5, the control section 101 calculates image formation conditions of different sections for obtaining the desired density in the image forming apparatus 100.

Further, in this case, under the image forming conditions obtained by density control, it is considered that the power of the LD 1723 during normal image formation is increased slightly during the image formation from page 6 onwards compared to the power until then.

In this case, the control section 101, the data of the target set value of automatic light amount control due to the light emission outside the area of horizontal scanning during image formation is set to a value (190) higher than the value (180) until then. Because of this, even the APC during normal image formation becomes a value satisfying the image formation conditions, and it becomes possible to carry out drive LD 1723 for light emission with the accurate amount of light in a more appropriate state. In this case, regarding the set value of automatic light amount control, it is sufficient to change the stored value in the APC register 115a for normal image formation.

As has been described above, by forming patches under a plurality of conditions between a plurality of sheets, and by calculating from the measured results, it is possible to carry out the lowest density control based on the nearest image forming density.

Further, when the image forming conditions are changed based on this density control, by changing the set value of the automatic light amount control during image formation in accordance with that, it becomes possible to carry out appropriate automatic light amount control.

Further, regarding the above processing, in the APC register for normal image formation 115a, it is desirable to store APC data for normal image formation extending over a plurality of between sheet intervals (or, various types of data extending over a plurality of pages related to the above described APC for normal image formation). By doing so, there is no need to rewrite the register for each interval between pages, faster processing becomes possible, and it becomes possible to carry out APC even for normal image formation even in the case of high speed image formation or image formation with a short between sheets interval.

In a similar manner, regarding the above processing, in the APC register 115b for the patch formation, it is desirable to store APC data for the patch formation extending over a plurality of between sheet intervals (or, various types of data extending over a plurality of pages related to the above described APC for the patch formation). By doing so, there is no need to rewrite the register for each interval between pages, faster processing becomes possible, and it becomes possible to carry out APC even for the patch formation even in the case of high speed image formation or image formation with a short between sheets interval.

Further, the above processing, in the case of a color image forming apparatus that carries out image formation in a plurality of colors, is carried out for each of the plurality of colors for each recording material. In addition, in the above processing, it is also possible to carry out control using respectively independent values for the plurality of colors.

According to the present preferred embodiment, the following effects are obtained.

(1) In addition to detecting the amount of light of the light emitting means and controlling that amount of light, a patch that is not transferred to the recording sheet is formed in the non-image transfer area on the photoreceptor and the image forming conditions are controlled based on the result of detecting the density of that patch, and, in the between sheet interval from one image formation period of forming images to be transferred to a recording sheet to the image formation period of forming images to be transferred to the next recording sheet, a patch is formed by carrying out light amount control for patch formation, and in addition, light amount control is being carried out for the formation of images that have to be transferred to a recording sheet.

Because of this, it becomes possible to carry out high accuracy density control by executing the two types of light amount control for patches for density control and normal image formation using the between sheets interval.

(2) In the between sheets interval, in addition to carrying out the light amount control for patch formation to match that patch formation at least once, the light amount control for the formation of images that have to be transferred to a recording sheet is carried out once.

Because of this, it is not only possible to carry out light amount control for the patches for density control using the between sheets interval, but also possible to carry out light amount control for normal image formation, and it is possible to carry out high accuracy density control. Therefore, even if the number of colors that are targets of density control increase, it is possible to carry out adjustment in the between sheets interval.

(3) Since the light amount control for patch formation and the light amount control for the formation of images that have to be transferred to a recording sheet are carried out referring to the beginning and end of the patch area signal indicating the area of patch formation including the between sheets interval, it becomes possible to carry out high accuracy density control by carrying out the two types of light amount control even during the between sheets interval during which no index signal is being generated.

(4) Since registers have been provided respectively for storing the parameters of the light amount control for patch formation and the light amount control for the formation of images that have to be transferred to a recording sheet, it becomes possible to read out and use the values from those registers, even in a short between sheet interval that is not long enough for rewriting by software, it becomes possible to carry out high accuracy density control by carrying out the two types of light amount control.

(5) Since in the light amount control register for the patches provided for each color of the recording material used for image formation are stored the light amount control target value data for patches in the between sheets intervals of a plurality of sheets, and since the control section carries out light amount control for patch formation in the between sheets intervals of a plurality of sheets by referring to the values stored in the light amount control register for patches, it becomes possible to carry out light control for patch formation by reading out the value in that register for light control for patches, and also, it becomes unnecessary to rewrite the value of the register for each page interval, and it becomes possible to carry out high accuracy density control even during the short time of the between sheets interval.

(6) Since in the light amount control register for normal image formation provided for each color of the recording material used for image formation are stored the light amount control target value data for normal image formation in the between sheets intervals of a plurality of sheets, and since the control section carries out light amount control for normal image formation in the between sheets intervals of a plurality of sheets by referring to the values stored in the light amount control register for normal image formation, it becomes possible to carry out light control for normal image formation by reading out the value in that register for light control for normal image formation, and also, it becomes unnecessary to rewrite the value of the register for each page interval, and it becomes possible to carry out high accuracy density control even during the short time of the between sheets interval.

(7) The emission of light by the light emitting section is stopped at the start of the patch area signal indicating the area of patch formation within the between sheets interval and the set value for light amount control for patch formation is given to the D-A converter, after that patch formation is made by carrying out initial automatic light amount control and automatic light amount control outside the area of each exposure scan, and at the end of the patch area signal the emission of light by the light emitting section is stopped and the set value for light amount control for the formation of images that are to be transferred to a recording sheet is given to the D-A converter, and after that the initial automatic light amount control and the automatic light amount control outside the area of each exposure scan are carried out.

Because of this, it becomes possible to carry out high accuracy density control by executing the two types of light amount control for the patch for density control and for the normal image formation using the between sheets interval.

Further, since the light amount control for patch formation and the light amount control for the formation of images that have to be transferred to a recording sheet are carried out referring to the beginning and end of the patch area signal indicating the area of patch formation within the between sheets interval, it is possible to carry out high accuracy density control by executing the two types of light amount control even in a between sheets interval in which an index signal is not being generated.

### Operation of Other Preferred Embodiments

Although in the explanation of the above preferred embodiment a laser diode LD was used as the light emitting section of the exposure section, the present invention is not restricted to this. For example, even for an LPH unit using LEDs, a light amount control or density control similar to the above explanation are possible.

Further, as the above image forming apparatus, although a copying machine or a printer was assumed, the present invention shall not be restricted to an image forming apparatus for office use, but can also be applied to a printer for medical use and to a photograph printer for DPE applications.

Further, in the above explanations, although explanations were given taking an individual image forming apparatus as a concrete example, it is possible to apply the above described preferred embodiment even to an image forming system in which the control section 101 and the part of the LD writing control section 110, and the processing unit 170 (the image forming unit or the print engine) are separated.

What is claimed is:

1. An image forming apparatus that forms a latent image by exposing a photoreceptor using a light emitting section, and transfers a toner image obtained by developing the latent image on to a recording sheet, the image forming apparatus comprises:
a control section that detects an amount of light emitted from said light emitting section and controls an amount of light emitted from said light emitting section, and forms a patch in a non-image transfer region of said photoreceptor, where an image to be transferred on to the recording sheet is not formed on the non-image transfer region, and controls the image forming conditions according to a detected result of density of the patch formed on the non-image transfer region;
wherein said control section, during an interval between sheets, which corresponds to an interval between a period of image formation of a first image to be transferred to said recording sheet and a period of image formation of a second image to be transferred to next recording sheet, forms said patch by carrying out light amount control for forming said patch, and carries out light amount control for forming images to be transferred to said recording sheet.

2. The image forming apparatus of claim 1, wherein the control section carries out at least once the light amount control for forming said patch during the interval between sheets, and carries out light amount control once for the formation of image to be transferred to said recording sheet.

3. The image forming apparatus of claim 1, wherein the control section carries out light amount control for forming said patch and the light amount control for the formation of the image to be transferred to said recording sheet referring to a beginning and end of a patch area signal indicating an area of patch formation within the interval between sheets.

4. The image forming apparatus of claim 1, further comprising:
registers respectively for storing parameters of the light amount control for forming said patch and the light amount control for the formation of the image to be transferred to a recording sheet,
wherein the light emitting section comprises a D-A converter whose output sets the amount of light of said light emitting section, and
wherein the control section gives set values for the control of the amount of light for forming said patch and the control of the amount of light for the formation of the image to be transferred to a recording sheet to said D-A converter referring to values stored in respective registers.

5. The image forming apparatus of claim 1, further comprising:
a light amount control register for a patch provided for each color of the recording material used for image formation, which stores target value data for patches in the interval between sheets,
wherein the control section carries out light amount control for patch formation in the interval between sheets by referring to the values stored in the light amount control register for patches.

6. The image forming apparatus of claim 1, further comprising:
a light amount control register for a normal image formation provided for each color of the recording material used for image formation, which stores target value data for a normal image formation in the interval between sheets,
wherein the control section carries out light amount control for normal image formation in the interval between sheets by referring to the values stored in the light amount control register for a normal image formation.

7. An image forming apparatus that forms a latent image by exposing a photoreceptor using a light emitting section, and transfers a toner image on to a recording sheet, the image forming apparatus comprising:
a D-A converter whose output sets the amount of light of said light emitting section, and
a control section that detects an amount of light emitted from said light emitting section and controls an amount of light emitted from said light emitting section, and forms a patch in a non-image transfer region of said photoreceptor, where an image to be transferred on to the recording sheet is not formed on the non-image transfer region, and controls the image forming conditions according to a detected result of density of the patch formed on the non-image transfer region;
wherein said control section, stops the emission of light from said light emitting section at the start of a patch region signal indicating a patch formation region within the interval between sheets and gives a set value of the control of the amount of light for forming said patch to said D-A converter, thereafter forming said patch by carrying out initial automatic light amount control and automatic light amount control outside the region for every exposure scan,
and wherein the control section, stops the emission of light from said light emitting section at the end of said patch region signal and gives a set value of the control of the amount of light for forming the image to be transferred to a recording sheet to said D-A converter, and thereafter carries out initial automatic light amount control and automatic light amount control outside the region for every exposure scan.

8. The image forming apparatus of claim 7, further comprising registers respectively for storing parameters of the light amount control for forming said patch and the light amount control for the formation of the image to be transferred to a recording sheet.

9. An image forming method for forming a latent image by exposing a photoreceptor using a light emitting section, and transferring a toner image obtained by developing the latent image on to a recording sheet, the image forming method comprises:
detecting an amount of light emitted from said light emitting section;
controlling an amount of light emitted from said light emitting section;
forming a patch in a non-image transfer region of said photoreceptor, where an image to be transferred on to the recording sheet is not formed on the non-image transfer region;
controlling the image forming conditions according to a detected result of density of the patch formed on the non-image transfer region; and
during an interval between sheets, which corresponds to an interval between a period of image formation of a first image to be transferred to said recording sheet and a period of image formation of a second image to be transferred to next recording sheet, forming said patch by carrying out light amount control for forming said patch, and carrying out light amount control for forming images to be transferred to said recording sheet.

10. The image forming method of claim 9, further comprising carrying out at least once the light amount control for forming said patch during the interval between sheets, and carrying out light amount control once for the formation of image to be transferred to said recording sheet.

11. The image forming apparatus of claim 9, further comprising carrying out light amount control for forming said patch and the light amount control for the formation of the image to be transferred to said recording sheet referring to a beginning and end of a patch area signal indicating an area of patch formation within the interval between sheets.

12. The image forming apparatus of claim 9, further comprising:
storing, respectively in registers, parameters of the light amount control for forming said patch and the light amount control for the formation of the image to be transferred to a recording sheet; and
giving set values for the control of the amount of light for forming said patch and the control of the amount of light for the formation of the image to be transferred to a recording sheet to a D-A whose output sets the amount of light of said light emitting section converter referring to values stored in respective registers.

13. The image forming apparatus of claim 9, further comprising:
storing target value data for patches in the interval between sheets,
carrying out light amount control for patch formation in the interval between sheets by referring to the values stored in the light amount control register for patches.

14. The image forming apparatus of claim 9, further comprising:
storing target value data for a normal image formation in the interval between sheets,
carrying out light amount control for normal image formation in the interval between sheets by referring to the values stored in the light amount control register for a normal image formation.
